(19) United States
(12) Patent Application Publication
(10) Pub. No.: US 2011/0300384 A1
(43) Pub. Date: Dec. 8, 2011

(54) POWDER, METHOD FOR PRODUCING SAME, AND RESIN COMPOSITION CONTAINING SAME

(75) Inventors: Yasuhisa Nishi, Fukuoka (JP); Hiroshi Murata, Fukuoka (JP)

(73) Assignee: DENKI KAGAKU KOGYO KABUSHIKI KAISHA, Tokyo (JP)

(21) Appl. No.: 13/141,133

(22) PCT Filed: Oct. 29, 2009
(86) PCT No.: PCT/JP2009/005730

§ 371 Date: Aug. 30, 2011

(30) Foreign Application Priority Data
Dec. 22, 2008 (JP) 2008-324881

(51) Int. Cl. B32B 5/16; B29C 67/02; C08K 3/22; B29C 35/02; C08L 63/00; C08K 3/36

(52) U.S. Cl. 428/402; 523/466; 523/457; 264/15

(57) ABSTRACT

Provided is a semiconductor sealing material in which the contamination rate of conductive foreign matter is extremely low. Further provided are powder comprising spherical silica powder and/or spherical alumina powder suitable for preparing such a semiconductor sealing material, a method for producing the same, and a resin composition. The powder comprises spherical silica powder and/or spherical alumina powder, and when a color reaction test for particles using an aqueous potassium ferricyanide solution under specific conditions is performed for magnetizable particles having a particle size of 45 [mu]m or more, the ratio of the number of particles which develop color to the total number of the magnetizable particles is 20% or less. Such powder can be produced by supplying a specific amount of oxygen gas and/or water vapor to at least one arbitrary site at which the atmospheric temperature is 1600 to 1800 DEG C. in a furnace at an angle of 60 DEG to 90 DEG with respect to the injection direction of a starting material of the powder, and setting the relative velocity of the starting material of the powder and/or the spherical powder to stainless steel and/or iron to 5 m/s or less.

This application is based on and claims the benefit of priority from Japanese Patent Application No. 2008-324881, filed on 22 Dec. 2008, the content of which is incorporated herein by reference.

### BACKGROUND OF THE INVENTION

1. Field of the Invention

The present invention relates to a powder composed of at least one of a spherical silica powder and a spherical alumina powder, a manufacturing method thereof, and a resin composition including the powder.

2. Related Art

In response to demands for reductions in size and weight and improvement in performance of electronic devices, reductions in size and thickness and high-density packaging of a semiconductor are rapidly advancing. As a result, for the structure of semiconductors, the number of semiconductors of an area array structure such as BGA and LGA, which are preferable for a reduction in thickness and high-density packaging, has been increasing more than the conventional lead terminal structure such as QFP and SOP. In addition, in recent years, a stacked chip structure in which a plurality of IC chips is stacked within a single semiconductor package is being actively adopted and the structure of semiconductors has been becoming increasingly complicated and high-density packaging of a semiconductor has progressed further. Furthermore, along with reductions in size and thickness and high-density packaging of a semiconductor, clearance between gold wires inside the semiconductor is becoming smaller, and recently a semiconductor having the clearance of about 50 μm is being put into practical use.

Meanwhile, a semiconductor sealant for packaging (sealing) a semiconductor is filled with a filler such as a silica powder and an alumina powder, in order to reduce a coefficient of thermal expansion, increase a coefficient of thermal conductivity, improve flame retardance, improve moisture resistance, and the like; however, minute metal particles may be mixed into such powder as a foreign material during a manufacturing process thereof. This is because a part of a manufacturing facility of the filler such as a silica powder and an alumina powder is generally made of metal such as iron and stainless steel, and thus a surface thereof is ground by the powder during pulverization of the powder, transferring by airflow, classifying and sifting, blending and the like. If conductive metal particles are thus mixed into a silica powder and an alumina powder that is to be filled into a semiconductor sealant, a short circuit is likely to develop between wires and the like of a semiconductor due to the conductive metal particles. Hence, various studies to remove or render harmless (nonconductive) such conductive metal particles mixed into a silica powder, an alumina powder and the like are being made.

As a technique to remove or render harmless (nonconductive) metal particles in a silica powder and an alumina powder, a method of putting a spherical silica powder including metal particles into a sulfuric acid water solution, thereby dissolving and removing the metal particles, is disclosed in Japanese Unexamined Patent Application Publication No. 2007-005346 (Patent Document 1). However, the method has a problem in that the spherical silica powder needs to be cleaned, heat-dried and crushed after acid treatment, which results in a high cost, and that there is a great risk that metal particles are mixed into the powder again during a heat-drying step and a crushing step for powderization thereof. As another problem, reliability of a semiconductor sealer filled with the spherical silica powder is decreased due to remaining sulfate ion. On the other hand, in order to oxidize a metal powder and render the metal powder nonconductive, a method of heating granular silica including metal particles in the atmosphere in a temperature range of 700 to 1500° C., thereby oxidizing the metal particles, is disclosed in Japanese Unexamined Patent Application Publication No. 2004-175825 (Patent Document 2). In this method, there is a problem in that a silica powder is fused and aggregated as a result of heating at a high temperature and that not all metal particles buried in the silica powder are oxidized. In addition, the method is not a perfect solution since, even if the metal particles are oxidized, an oxide layer is present only on a surface of the metal particles due to low heating temperature, and thus, depending on the thickness and mechanical strength of the oxide layer, the metal particles may again become conductive particles when the oxide layer is broken. Meanwhile, in a technique of fusing at least one of a silica raw material powder and an alumina raw material powder by a flame formed inside a furnace, sphering, transferring to outside of the furnace, and then collecting a spherical powder, a method of injecting gas such as air, oxygen gas and the like inside the furnace in order to prevent the powder from sticking to an interior wall of the furnace is proposed in Japanese Unexamined Patent Applications Publication Nos. 2001-233627 (Patent Document 3) and S60-106524 (Patent Document 4).

### SUMMARY OF THE INVENTION

An objective of the present invention is to provide a powder composed of at least one of a spherical silica powder and a spherical alumina powder, which is preferable for preparing a semiconductor sealant used for sealing a downsized and high-density semiconductor, containing no conductive foreign material or a very low concentration thereof, a manufacturing method thereof, and a resin composition including the powder.

The present invention provides a powder consisting of at least one of a spherical silica powder and a spherical alumina powder, in which a proportion of a number of magnetic colored particles of no less than 45 μm in diameter is no greater than 20% with respect to a total number of the magnetic colored particles of no less than 45 μm in diameter and magnetic non-colored particles of no less than 45 μm in diameter, in a case where the following color reaction test is conducted.

(1) preparing a slurry, by way of precisely weighing 50 g of a powder sample and dispersing the powder sample in 800 g of ion-exchanged water;

(2) obtaining the total number of the magnetic colored particles of no less than 45 μm in diameter and magnetic non-colored particles of no less than 45 μm in diameter, by way of capturing magnetic particles by immersing a bar magnet of 10000 gauss covered by a rubber cover of 20 μm thickness in the slurry, sifting the magnetic particles with a polyester filter of 45-μm mesh size, counting a number of the particles remaining on the filter;

(3) wetting the particles by way of dripping 0.5 ml of a mixed solution comprising equal parts of 10% by mass hydrochloric acid water solution, 50% by mass propylene glycol water solution, and 0.5% by mass potassium ferricyanide water solution, on the particles on the filter at a room temperature of 20° C., then leaving to stand for 20 minutes, counting a number of particles thus colored as the magnetic colored particles of no less than 45 μm in diameter, and calculating the proportion of the number of magnetic colored particles of no less than 45 μm in diameter present among magnetic particles of no less than 45 μm in diameter by an equation (Number of magnetic colored particles of no less than 45 μm in diameter)×100/(Total number of magnetic colored particles of no less than 45 μm in diameter and magnetic non-colored particles of no less than 45 μm in diameter); and (4) selecting magnetic non-colored particles having a particle diameter after the color reaction test of no less than 45 μm, embedding with epoxy resin, curing, cutting and polishing to expose a cross-section of the particle, analyzing for the existence of oxygen in a center of the cross-section using energy-dispersive X-ray spectroscopy (EDS), counting a number of particles in which oxygen is detected in the center of the cross-section thereof as a number of particles oxidized down to a central portion thereof, and calculating the proportion of the number of particles oxidized down to the central portion thereof present among magnetic non-colored particles of no less than 45 μm in diameter by an equation (Number of particles oxidized down to a central portion thereof)×100/(Number of magnetic non-colored particles of no less than 45 μm in diameter), in which analysis conditions of the EDS are: accelerating voltage of 15 kV; illumination current of 10 nA, magnification of 2000 times, elapsed time for each pixel of 100 msec, pixel size of 0.2 μm square, and pixel count of 256×256 pixels.

In the present invention, it is preferable that:

i) the number of the magnetic colored particles of no less than 45 μm in diameter is no greater than 5 per 50 g;

ii) the total number of the magnetic colored particles of no less than 45 μm in diameter and magnetic non-colored particles of no less than 45 μm in diameter is no greater than 50 per 50 g;

iii) a proportion of a number of particles oxidized down to a central portion thereof is no less than 60%, particularly preferably no less than 70%; or

iv) the powder has an average sphericity of no less than 0.75 and an average particle diameter in a range of 3 to 50 μm.

In addition, the present invention also provides a manufacturing method of a powder consisting of at least one of a spherical silica powder and a spherical alumina powder, including a process of fusing at least one of a silica raw material powder and an alumina raw material powder by a flame formed inside a furnace, sphering, transferring to outside of the furnace, and collecting a spherical powder, in which the process includes steps of: supplying 0.3 to 0.6 m³ of at least one of oxygen gas and water vapor per 1 kg of a raw material powder to at least one arbitrary site inside the furnace where an ambient temperature is in a range of 1600 to 1800° C., at an angle of 60° to 90° with respect to an injection direction of the raw material powder; and between fusing and sphering of the raw material powder and collecting the spherical powder, in a portion where at least one of the raw material powder and the spherical powder contact at least one of stainless steel and iron, making a relative velocity therebetween no greater than 5 m/s. In the present invention, the powder consisting of at least one of a spherical silica powder and a spherical alumina powder is preferably any one of the powders according to the present invention.

The present invention also provides a resin composition including the powder according to the present invention.

According to the present invention, a powder composed of at least one of a spherical silica powder and a spherical alumina powder, which is preferable for preparing a semiconductor sealant used for sealing a downsized and high-density semiconductor, containing no conductive foreign material or a very low concentration thereof, a manufacturing method thereof, and a resin composition including the powder are provided.

### DETAILED DESCRIPTION OF THE INVENTION

The powder according to the present invention is composed of at least one of a spherical silica powder and a spherical alumina powder. A semiconductor sealant using a silica powder has an advantage of having a lower coefficient of thermal expansion than that using an oxide powder other than a silica powder. A semiconductor sealant using an alumina powder has an advantage of having a higher coefficient of thermal conductivity than that using an oxide powder other than an alumina powder. The powder composed of at least one of a spherical silica powder and a spherical alumina powder can be either of the two powders or a mixed powder thereof.

An average sphericity of the powder according to the present invention is preferably no less than 0.75, particularly preferably no less than 0.80, and more preferably no less than 0.90. Such an average sphericity can lower the viscosity of the semiconductor sealant and can easily suppress defects such as wire sweep at the time of sealing. The average sphericity is measured as follows. First, an image of a particle taken by a stereo microscope (SMZ-10 manufactured by Nikon Corporation) is loaded to an image analyzer (MacView manufactured by MOUNTECH Co., Ltd.) and a projected area (A) and a perimeter (PM) of the particle are measured from the image. In a case where an area corresponding to the perimeter (PM) is taken as (B), an average sphericity of the particle is A/B. Supposing a perfect round having the same perimeter as the perimeter (PM) of the sample, PM=2πr and B=πr², and thus B=π×(PM/2π)². Therefore, sphericity of each particle can be obtained by an equation A/B=A×4π/(PM)². The sphericity of 200 arbitrary particles is thus obtained, and an average value thereof is obtained as an average sphericity.

An average particle diameter of the powder according to the present invention is preferably in a range of 3 to 50 μm. An average particle diameter of less than 3 μm increases viscosity of the semiconductor sealant and may cause deformation of a semiconductor wire at the time of sealing. On the other hand, with an average particle diameter of greater than 50 μm, coarse particles may damage a semiconductor chip and may collide with and deform a semiconductor wire. A particularly preferable average particle diameter is in the range of 5 to 45 μm. An average particle diameter is a diameter of a particle having an accumulative value of 50% by mass in an accumulative granularity distribution of the powder, and is measured based on granularity measurement by a laser diffraction scattering method. In the present invention, a measuring instrument (trade name: Cilas Granulometer Model 920, manufactured by Cilas) is used for measuring, after mixing water with the powder and dispersing the powder by a supersonic homogenizer, at 200 W power output for 1 minute. Here, particle diameter channels are: 1; 1.5; 2; 3; 4; 6; 8; 12; 16; 24; 32; 48; 64; 96; 128; and 196 μm.

Amorphous rate (fusion rate) of the silica powder according to the present invention is preferably no less than 98% by mass. Amorphous rate is determined by carrying out an X-ray diffraction analysis of a sample for the 2θ of CuKα-rays ranging from 26° to 27.5°, using a powder X-ray diffraction analyzer (trade name: MiniFlex, manufactured by RIGAKU Co., Ltd.), and then determining the amorphous rate on the basis of the intensity ratio of specific diffraction peaks thus obtained. In a case of a silica powder, crystalline silica shows a main peak at 26.7°, while amorphous silica does not show a peak. For this reason, if a sample includes both crystalline and amorphous silica, the height of the main peak appearing at an angle of 26.7° is proportional to the content of the crystalline silica. Accordingly, the content of the crystalline silica ((the intensity of the X-ray diffraction for the sample)/(the intensity of the X-ray diffraction for the reference sample of crystalline silica)) is calculated from the ratio of the X-ray intensity observed for the sample to that observed for the reference sample of crystalline silica and then the amorphous rate is calculated according to the following equation:

Amorphous rate (% by mass)=(1-Content of Crystalline Silica)×100.

In the powder according to the present invention, a proportion of a number of magnetic colored particles of no less than 45 μm in diameter is no greater than 20%, preferably no greater than 15%, and particularly preferably no greater than 10% with respect to a total number of the magnetic colored particles of no less than 45 um in diameter and magnetic non-colored particles of no less than 45 um in diameter, in a case where the abovementioned color reaction test is conducted. The presence of dark blue colored particles among the magnetic particles of no less than 45 μm in diameter (in other words, the magnetic colored particles of no less than 45 μm in diameter) indicates that a part or all of the magnetic particles release Fe ions while being dissolved in a 10% by mass hydrochloric acid water solution, thus showing that the magnetic particles are conductive. The magnetic colored particles of no less than 45 μm in diameter are stainless steel particles, iron particles and the like, and the magnetic non-colored particles of no less than 45 μm in diameter are typically iron oxide particles. In the color reaction test, both the magnetic colored particles and the magnetic non-colored particles are captured by a bar magnet of 10000 gauss.

A relationship between magnetic properties of the magnetic particles of no less than 45 μm in diameter and the conductivity of the magnetic colored particles of no less than 45 μm in diameter is described further in detail hereinafter. Almost all of the magnetic particles mixed into a powder are stainless steel (SUS304, SUS316, SUS430 and the like) particles, iron (Fe) particles, and oxides thereof originated from abrasion, cutting, peeling and the like of manufacturing facility. In a manufacturing process of a powder, a part of heated stainless steel particles and iron particles have an oxide layer such as hematite (Fe₂O₃) and magnetite (Fe₃O₄), in order from outside, formed; however, both thereof can be captured using a magnet of at least 1000 gauss. Here, the stainless steel particles and the iron particles are hydrochloric acid-soluble and conductive. On the other hand, hematite is very low in hydrochloric acid-solubility and almost nonconductive. Therefore, if the solubility of the magnetic particles in a hydrochloric acid water solution can be determined, conductivity thereof can also be determined. In other words, magnetic colored particles from which surface iron ions are released through the action of the hydrochloric acid water solution and that give a dark blue color reaction when contacting a potassium ferricyanide water solution, can be determined to be stainless steel particles or iron particles that are conductive, while magnetic non-colored particles that do not give a color reaction can be determined to be an oxide thereof having at least a hematite layer that are nonconductive or very low in conductivity. The powder according to the present invention is configured on the basis of such a novel aspect.

In a case where, the proportion of the number of magnetic colored particles of no less than 45 μm in diameter is greater than 20% with respect to a total number of the magnetic colored particles and magnetic non-colored particles of no less than 45 μm in diameter, a short circuit failure ratio of a semiconductor that is sealed using the semiconductor sealant rises sharply. It should be noted that it is preferable for the proportion of the number of magnetic colored particles of less than 45 μm in diameter to be low; however, such particles are not likely to connect gold wires and cause a short circuit failure of the semiconductor since clearance between the gold wires in the latest semiconductors is about 50 μm. Therefore, limiting the proportion of the number of magnetic colored particles of no less than 45 μm in diameter has an important significance at present.

In the powder according to the present invention, the number of the magnetic colored particles of no less than 45 μm in diameter is preferably no greater than 5 per 50 g, particularly preferably no greater than 3 per 50 g. This promotes an effect of the present invention. The number of the magnetic colored particles of no less than 45 μm in diameter is ideally zero; however, an amount of the powder in the semiconductor sealant used for a single semiconductor is about 1 to 3 g, and thus a short circuit failure ratio due to the powder tends to be minuscule, stochastically. Hence, in a case where the number of the magnetic colored particles of no less than 45 μm in diameter is no greater than 5 per 50 g, a sufficient effect can be achieved from the viewpoint of mitigating short circuit failure of a semiconductor. In addition, the total number of the magnetic colored particles of no less than 45 μm in diameter and magnetic non-colored particles of no less than 45 μm in diameter (in other words, a number of magnetic particles of no less than 45 μm in diameter) being no greater than 50 per 50 g, particularly no greater than 40 per 50 g, can further promote the effect of the present invention. Since the magnetic non-colored particles that are nonconductive have a risk of again becoming conductive due to destruction of the oxide layer such as hematite, depending on a handling method thereof, the risk can thus be lowered in advance.

In the powder according to the present invention, the proportion of the number of particles that are oxidized down to a central portion thereof is preferably no less than 60%, particularly preferably no less than 70%, the proportion being calculated by performing the abovementioned step (4). As a result, even if a superficial layer of the magnetic non-colored particles is broken, the particles have a very small risk of again becoming conductive since many of the particles are oxidized down to a central portion thereof. It should be noted that, even in a case where the proportion of the number of particles that are oxidized down to a central portion thereof is less than 60%, the effect of the present invention is not substantially impaired.

Operations in steps (1) and (2) in the color reaction test were performed according to a disclosure in the Japanese Unexamined Patent Application Publication No. 2008-145246 (Paragraphs [0023] to [0025]), except for having changed material and opening size of a filter. In addition, as the EDS used in step (4), INCA EDS (trade name, manufactured by Oxford Instruments plc) attached to a JSM-6301F scanning electron microscope (trade name, manufactured by JEOL Ltd.) was used. A diamond cutter was used for cutting the magnetic non-colored particles and mirror polishing was performed using diamond abrasive grains for cross-section polishing. For cross-section observation, osmium was vapor-deposited in a thickness of 5 nm using an osmium coater in order to impart conductivity. Under such conditions, images of ten cross-sections of arbitrary magnetic non-colored particles of no less than 45 μm in diameter were taken. Furthermore, the particles were magnified using a microscope in order to count a number thereof.

A method for increasing and decreasing the number of magnetic colored particles of no less than 45 μm in diameter and magnetic non-colored particles of no less than 45 μm in diameter, in a case of the powder according to the present invention, is described later. As an example thereof, a number of the magnetic colored particles can be decreased and a number of particles that are oxidized down to a central portion thereof can be increased by increasing a supplied amount of at least one of oxygen gas and water vapor with respect to a raw material powder under an atmosphere of higher temperature in order to accelerate oxidization of the magnetic particles. In addition, by making a relative velocity between at least one of a raw material powder and a spherical powder and at least one of stainless steel and iron no greater than 5 m/s, the total number of the magnetic colored particles of no less than 45 μm in diameter and magnetic non-colored particles of no less than 45 μm in diameter can be decreased. An average particle diameter of the powder can be increased and decreased by adjusting an average particle diameter of the raw material powder. An average sphericity thereof can be increased by lowering a supplied amount of the raw material powder to a flame.

A manufacturing method of the powder according to the present invention is described hereinafter.

In a conventional manufacturing method of the powder, a burner that can strongly disperse and inject a raw material powder into a flame is used in order to increase the average sphericity and to avoid particles from being fused in an aggregated state. However, the burner disperses the raw material powder so strongly that there are particles going out of the flame without a sufficient thermal history inside the flame. As a result, there have been a large number of magnetic particles that are not oxidized. In addition, even if the magnetic particles are once oxidized, there have been magnetic particles that are reduced by a carbon component, a hydrogen component and the like in flammable gas for generating the flame (for example, propane gas) and go out of the flame in an almost unoxidized state. The manufacturing method of the present invention can manufacture the powder of the present invention while eliminating such problems.

In the manufacturing method of the present invention, at least one of a silica raw material powder and an alumina raw material powder is fused by a flame formed inside a furnace, sphered and transferred to outside of the furnace, and a spherical powder is collected. As a device that can perform the method, a furnace body including a burner to which a collection device is connected can be exemplified. The furnace body can be either vertical or horizontal. The collection device is provided at least one of a gravity-settling chamber, a cyclone separator, a bag filter, an electrostatic dust collector and the like, and can collect a spherical powder by adjusting collection condition thereof. An example thereof is disclosed in Japanese Unexamined Patent Application Publications Nos. H11-57451, 2001-233627, and the like.

The manufacturing method of the present invention has a first requirement of supplying 0.3 to 0.6 m³ of at least one of oxygen gas and water vapor per 1 kg of a raw material powder toward at least an arbitrary site inside the furnace where an ambient temperature is in a range of 1600 to 1800° C., at an angle of 60° to 90° with respect to an injection direction of a raw material powder. In a case where the at least one of oxygen gas and water vapor is supplied from a plurality of sites, the total amount thereof is 0.3 to 0.6 m³.

A site of the furnace body where an ambient temperature is in a range of 1600 to 1800° C. can be identified by measurement using a B-type thermocouple (measurable range: 0 to 1800° C.), IrRh thermocouple (measurable range: 1100 to 2000° C.) and the like. Generally, the site is immediately behind a position where the raw material powder is fused and sphered by flame temperature and the raw material powder and the spherical powder float. By supplying at least one of oxygen gas and water vapor to the site, stainless steel particles and iron particles not only become easy to be heated, but can sufficiently contact at least one of oxygen gas and water vapor. As a result, the number of the magnetic colored particles of no less than 45 μm in diameter can be surely reduced and the number of particles that are oxidized down to a central portion thereof can be increased. If an ambient temperature of a site where at least one of oxygen gas and water vapor is supplied is lower than 1600° C., the abovementioned action becomes less effective, whereas if the ambient temperature exceeds 1800° C., the oxygen gas is consumed in a combustion reaction and does not contribute to oxidization of the magnetic particles, and water vapor lowers the temperature of the flame and may inhibit fusing and sphering of the raw material powder. A preferable ambient temperature is in the range of 1700 to 1800° C. It should be noted that, supply of air or nitrogen gas cannot sufficiently oxidize the stainless steel particle and the iron particles.

Patent Document 2 discloses a method of heating granular silica powder in the atmosphere at a temperature of 700 to 1500° C., thereby oxidizing metal particles in the granular silica powder. However, in this method, there is a problem in that a silica powder is fused and aggregated as a result of heating at a high temperature, not all metal particles buried in the silica powder are oxidized, and only a superficial layer thereof is oxidized. This is proven by a color reaction test of a powder prepared according to Examples 1 to 3 of Patent Document 2, where a proportion of a number of magnetic colored particles of no less than 45 μm in diameter was about 40 to 70% with respect to a total number of the magnetic colored particles of no less than 45 μm in diameter and magnetic non-colored particles of no less than 45 μm in diameter.

If a supplied amount of at least one of oxygen gas and water vapor is smaller than 0.3 m³ per 1 kg of the raw material powder, the abovementioned action becomes less effective since the stainless steel particles and the iron particles cannot sufficiently contact at least one of oxygen gas and water vapor, whereas if the supplied amount exceeds 0.6 m³, fusing and sphering of the raw material powder may be inhibited. A preferable supplied amount of at least one of oxygen gas and water vapor is in the range of 0.4 to 0.5 m³ per 1 kg of the raw material powder.

To supply at least one of oxygen gas and water vapor toward at least an arbitrary site where an ambient temperature is in the range of 1600 to 1800° C., at an angle of 60° to 90° with respect to an injection direction of the raw material powder, a supply tube of at least one of oxygen gas and water vapor can be attached to the furnace body at an adjusted angle. If a supply angle is outside of the abovementioned range, the stainless steel particles and the iron particles cannot sufficiently contact at least one of oxygen gas and water vapor, and the abovementioned action may become less effective. A supply angle is preferably in a range of 70° to 90°, particularly preferably 90° (at a right angle), with respect to an injection direction of the raw material powder.

A supply tube of at least one of oxygen gas and water vapor is installed at least in one site inside the furnace body, and preferably installed at four sites so that straight lines connecting opposing sites are orthogonal to each other. By thus installing the supply tube, the stainless steel particles and the iron particles can sufficiently contact at least one of oxygen gas and water vapor. As a result, the number of the magnetic colored particles of no less than 45 μm in diameter can be reduced and the number of particles that are oxidized down to a central portion thereof can be increased. More preferably, the supply tube is provided at 4 locations in each circumference on planes at a position spaced 50 cm above and below this installation position, i.e. at a total of 12 sites. This makes it easy to supply at least one of oxygen gas and water vapor to a site where an ambient temperature is in the range of 1600 to 1800° C., and therefore the stainless steel particles and the iron particles can further sufficiently contact ,at least one of oxygen gas and water vapor.

The manufacturing method of the present invention has a second requirement of, between fusing and sphering of the raw material powder and collecting thereof, in a site where at least the raw material powder and the spherical powder contact at least one of stainless steel and iron, making a relative velocity therebetween no greater than 5 m/s.

The relative velocity used herein is, in a case where a constituent member of the device is immobile, such as a fixed pipe, a traveling velocity of at least one of the raw material powder and the spherical powder (for example, airflow transfer velocity and fall velocity thereof), and, in a case where the powder is immobile, such as a spherical powder stored in a collection device, a traveling velocity of a constituent member of the device (for example, a sliding velocity of a slide plate and a peripheral speed of rotary valve). The relative velocity regulated in the present invention is a relative velocity between at least one of a raw material powder and a spherical powder and at least one of stainless steel and iron, which is no greater than 5 m/s. If the relative velocity exceeds 5 m/s, at least one of stainless steel and the iron is abraded and there is a risk of magnetic colored particles of no less than 45 μm in diameter being mixed in the powder and of oxidized magnetic non-colored particles being broken and again becoming magnetic colored particles. A relative velocity in the site is preferably no greater than 4 m/s, and more preferably no greater than 3 m/s. In a site where the relative velocity exceeds 5 m/s, at least one of the stainless steel and the iron should not be exposed and is to be lined with a nonmetallic material such as alumina, natural rubber, urethane and the like.

A resin composition according to the present invention is described hereinafter.

The resin composition of the present invention includes a resin and the powder of the present invention. The content of the powder in the resin composition is preferably 10 to 95% by mass, and more preferably 40 to 93% by mass. As the resin, epoxy resin, silicone resin, phenol resin, melamine resin, urea resin, unsaturated polyester, fluorine resin, a polyamide such as polyimide, polyamide-imide and polyetherimide, polyester such as polybutylene terephthalate and polyethylene terephthalate, polyphenylene sulfide, aromatic polyester, polysulfone, liquid crystal polymer, polyether sulfone, polycarbonate, maleimide-modified resin, ABS resin, AAS (acrylonitrile-acrylic rubber styrene) resin, ABS (acrylonitrile ethylene propylene diene rubber-styrene) resin and the like can be exemplified.

Among these, the resin in the resin composition used for a semiconductor sealant is preferably epoxy resin having no less than 2 epoxy groups in one molecule, such as: phenolic novolac-type epoxy resin, ortho cresol novolac-type epoxy resin, epoxidized novolac resin of phenols and aldehydes, glycidyl ether such as bisphenol-A, bisphenol-F, bisphenol-S and the like, glycidyl ester acid epoxy resin obtained by a reaction of polybasic acid such as phthalic acid and dimer acid with epochlorohydrin, linear aliphatic epoxy resin, alicyclic epoxy resin, heterocyclic epoxy resin, alkyl-modified polyfunctional epoxy resin, β-naphthol novolac-type epoxy resin, 1,6-dihydroxynaphthalene-type epoxy resin, 2,7-dihydroxynaphthalene-type epoxy resin, bishydroxy biphenyl-type epoxy resin, and epoxy resin into which a halogen such as bromine is introduced for flame retardancy. From the viewpoint of humidity resistance and reflow soldering resistance, ortho cresol novolac-type epoxy resin, bishydroxy biphenyl-type epoxy resin, epoxy resin of naphthalene framework and the like are preferable.

The resin composition being an epoxy resin composition includes a curing agent for epoxy resin, or a curing agent for epoxy resin with a curing accelerating agent for epoxy resin. As the curing agent for epoxy resin, a novolac-type resin obtained by reaction of one or a mixture of at least two selected from a group of: phenol; cresol; xylenol; resorcinol; chlorophenol; t-butylphenol; nonylphenol; isopropylphenol; octyl phenol; and the like with formaldehyde, paraformaldehyde or paraxylene under an oxidation catalyst, polyparahydroxystyrene resin, a bisphenol compound such as bisphenol-A and bisphenol-S, trifunctional phenol such as pyrogallol and phloroglucinol, an acid anhydride such as maleic anhydride, phthalic anhydride and pyromellitic anhydride, an aromatic amine such as metaphenylenediamine, diaminodiphenylmethane, diaminodiphenylsulfone can be exemplified. In order to accelerate reaction of epoxy resin with a curing agent, the abovementioned curing accelerating agent such as triphenylphosphine, benzyldimethylamine, and 2-methylimidazole is preferably used.

The resin composition of the present invention can further include the following components as necessary:

a rubber-like material such as silicon rubber, polysulfide rubber, acrylic rubber, butadiene rubber, styrene block copolymer and saturated elastomer, various thermoplastic resins, a resin-like material such as silicone resin, epoxy resin or phenol resin partially or fully modified by amino silicone, epoxy silicone, alkoxy silicone and the like as a stress lowering agent;

epoxy silane such as γ-glycidoxypropyltrimethoxysilane and β-(3,4-epoxycyclohexyl)ethyltrimethoxysilane, amino silane such as aminopropyltriethoxysilane, ureidopropyltriethoxysilane and N-phenylaminopropyltrimethoxysilane, a hydrophobic silane compound such as phenyltrimethoxysilane, methyltrimethoxysilane and octadecyltrimethoxysilane, mercaptosilane and the like as a silane coupling agent;

a Zr chelate, titanate coupling agent, aluminum coupling agent and the like as a surface preparation agent;

Sb203, Sb204, Sb205 and the like as a flame-retardant assistant; halogenated epoxy resin, a phosphorous compound and the like as a flame retardant;

carbon black, iron oxide, dye, pigment and the like as a coloring agent; and

natural wax, synthetic wax, metal salt of straight-chain fatty acid, acid amide, esters, paraffin and the like as a parting agent.

The resin composition of the present invention can be manufactured by blending a predetermined amount of the abovementioned materials by way of a blender, a Henschel mixer or the like, kneading the mixture by way of a heating roller, a kneader, single screw or twin screw extruding machine or the like, cooling, and pulverizing.

### Examples

### Examples 1 to 7, Comparative Examples 1 to 9

A commercially available crystalline silica powder S1 (average particle diameter 26 μm), S2 (average particle diameter 5 μm), S3 (average particle diameter 45 μm), an alumina powder A1 (average particle diameter 31 μm), A2 (average particle diameter 3 μm), and A3 (average particle diameter 51 μm) were prepared as shown in Table 1 were provided. Each of these raw material powders was fused and sphered in a flame under the manufacturing conditions shown in Tables 2 and 3, thereby obtaining various spherical silica powders and spherical alumina powders.

The device used was a device disclosed in FIG. 1 of Japanese Unexamined Patent Application Publication No. H11-57451 with the following improvement. The device used in Comparative Example 9 was the device without the following improvement.

i) A supply tube of at least one of oxygen gas and water vapor was provided in concyclic sites in a furnace body where an ambient temperature measured by a B-type thermocouple was 1500° C., 1600° C., 1700° C., 1800° C. or 1900° C., at 30°, 60°, 90° or 12C° with respect to an injection direction of the raw material powder (downward direction in FIG. 1 of Japanese Unexamined Patent Application Publication No. H11-57451) by adjusting with a bearing. The supply tubes were installed in four sites so that straight lines connecting opposing sites were orthogonal to each other.

ii) A site of contact with a powder of a burner is made of an alumina tube, and an alumina brick was applied on an interior wall of the furnace body.

iii) Sites where a relative velocity between a powder and at least one of stainless steel and iron was greater than 5 m/s, more specifically an exhaust channel opening (9), a primary powder retrieval opening (10), and a secondary powder retrieval opening (11) in FIG. 1 of Japanese Unexamined Patent Application Publication No. H11-57451, were lined with alumina. In addition, a secondary powder retrieval device bag filter (12) was lined with natural rubber.

iv) A peripheral speed of a rotary valve made of stainless SUS304, provided in an outlet of the secondary powder retrieval opening, was adjusted to be in the range of 1 to 18 m/s. It should be noted that, in the following test, the primary powder retrieval opening was closed and not used, and all the powder was retrieved from the secondary powder retrieval opening.

At least one of oxygen gas and water vapor was supplied equally from the four supply tubes at a rate of 0 to 1.0 m³ per 1 kg of the raw material powder in total. The temperature of the oxygen gas was 20° C. and the temperature of the water vapor was 105 to 110° C. A supplied amount of the raw material powder was 100 to 170 kg/hr. Propane gas and oxygen gas were used in forming a flame. The maximum temperature of the flame was about 2000 to 2100° C., which is higher than the fusing point of alumina.

A number of magnetic colored particles of no less than 45 μm in diameter, a number of magnetic non-colored particles of no less than 45 μm in diameter, and a number of magnetic non-colored particles that were oxidized down to a central portion thereof, in at least one of a spherical silica powder and a spherical alumina powder that was collected, were counted. In addition, average sphericity and average particle diameter of the spherical silica powder and the spherical alumina powder were measured. Results thereof are shown in Tables 1 and 2. Amorphous rate of the spherical silica powder was no less than 99% by mass in all cases.

In order to evaluate characteristics of the spherical silica powder and the spherical alumina powder as a filler for a semiconductor sealant, the following test was conducted. Results thereof are shown in Tables 1 and 2. Manufacture of Semiconductor Sealant Tablet

To 87.8 parts (by mass) of each powder, 5.9 parts of biphenyl-type epoxy resin (YX-4000H manufactured by Japan Epoxy Resins Co., Ltd.), 5.1 parts of phenolaralkyl resin (XLC-LL manufactured by Mitsui Chemicals, Inc.), 0.2 parts of triphenylphosphine, 0.6 parts of mercaptosilane coupling agent, 0.: parts of carbon black, and 0.3 parts of carnauba wax were added and dryblended by way of a Henschel mixer, and heated and kneaded by way of a co-rotating intermeshing twin screw extruding and kneading machine (screw diameter D=25 mm, kneading disk length of 10D mm, paddle revolution speed of 50 to 120 rpm, 2.5 kg/hr discharge rate, and kneaded product temperature of 99 to 100° C.). The kneaded product was pressed by a pressing machine and cooled, pulverized and tableted, thereby manufacturing a semiconductor sealant tablet (17 mm in diameter, 32 mm H). Number of short circuit failure in a semiconductor was evaluated as described in the following. In order to avoid commingling of magnetic particles from a facility and an apparatus for manufacturing the semiconductor sealant, all sites contacting the material were formed of any one of alumina, tungsten carbide, and urethane. Measurement of Number of Short Circuit Failure in Semiconductor

A semiconductor device of 8 mm×8 mm×0.3 mm in size was placed on a BGA substrate via a die attach film and connected with the substrate by a gold wire, then a semiconductor sealant tablet was molded into a package size of 38 mm×38 mm×1.0 mm using a transfer molding machine and post-cured at 175° C. for 8 hours, thereby manufacturing a BGA semiconductor. The diameter of the gold wire was 20 μm, the pitch thereof was 80 μm, and the clearance therebetween was 60 μm. Thirty semiconductors were manufactured using the same semiconductor sealant tablet and the number of semiconductors with short circuit failure was counted. Wire Deformation Volume of Semiconductor

The gold wire in the BGA semiconductor manufactured above was observed by a soft X-ray transmission device, the maximum gold wire sweep distance due to packaging was measured for the 30 semiconductors, and then an average value thereof was obtained as the wire deformation volume.

TABLE 1

| | Crystalline | Crystalline | Crystalline | Alumina | Alumina | Alumina |
|---|---|---|---|---|---|---|
| Raw material powder | silica S1 | silica S2 | silica S3 | A1 | A2 | A3 |
| Average particle diameter of raw material powder | 26 | 5 | 45 | 31 | 3 | 51 |
| (μm) | | | | | | |
| Number of magnetic colored particles of no less | 34 | 45 | 39 | 41 | 54 | 38 |
| than 45 μm in diameter (per 50 g) | | | | | | |
| Number of magnetic non-colored particles of no | 0 | 0 | 0 | 0 | 0 | 0 |
| less than 45 μm in diameter (per 50 g) | | | | | | |
| Total number of magnetic colored particles and | 34 | 45 | 39 | 41 | 54 | 38 |
| magnetic non-colored particles of no less than 45 | | | | | | |
| μm in diameter (per 50 g) | | | | | | |
| Proportion of number of magnetic colored | 100 | 100 | 100 | 100 | 100 | 100 |
| particles of no less than 45 μm in diameter (%) | | | | | | |
| Proportion of number of particles oxidized down to | 0 | 0 | 0 | 0 | 0 | 0 |
| central portion (%) | | | | | | |

TABLE 2

| | | Examples | | | | | | |
|---|---|---|---|---|---|---|---|---|
| | | 1 | 2 | 3 | 4 | 5 | 6 | 7 |
| | | Crystalline | Alumina | Crystalline | Alumina | Crystalline | Alumina | Crystalline |
| Type of raw material powder | | silica S1 | A1 | silica S2 | A2 | silica S3 | A3 | silica S1 |
| Average particle diameter of raw material powder (μm) | | 26 | 31 | 5 | 3 | 45 | 51 | 26 |
| Amount of raw material powder injected to flame (kg/hr) | | 140 | 140 | 100 | 100 | 150 | 150 | 140 |
| Oxygen carrier gas flow rate (m³/hr) | | 12 | 12 | 12 | 12 | 12 | 12 | 12 |
| Flame forming gas | Propane gas | 24 | 24 | 24 | 24 | 24 | 24 | 24 |
| flow rate (m³/hr) | Oxygen gas | 135 | 135 | 135 | 135 | 135 | 135 | 135 |
| Conditions of gas | Type | Oxygen | Oxygen | Oxygen | Oxygen | Oxygen | Oxygen and | Water |
| supplied | Total flow rate of 4 sites (m³/hr) | | | | | | water vapor | vapor |
| | Ratio of raw material powder (m³/kg) | 70 | 70 | 40 | 40 | 45 | 45 | 85 |
| | Ambient temperature in furnace (° C.) | 0.5 | 0.5 | 0.4 | 0.4 | 0.3 | 0.3 | 0.5 |
| | Supply angle (°) | 1800 | 1800 | 1600 | 1600 | 1700 | 1700 | 1700 |
| | | 90 | 90 | 90 | 90 | 60 | 60 | 90 |

| | | | | | | | |
|---|---|---|---|---|---|---|---|
| Peripheral speed of rotary valve (m/s) | 3 | 3 | 3 | 3 | 3 | 3 | 3 |
| Number of magnetic colored particles of no less than 45 μm | 0 | 0 | 1 | 2 | 1 | 1 | 0 |
| in diameter (per 50 g) | | | | | | | |
| Number of magnetic non-colored particles of no less than | 33 | 41 | 44 | 52 | 38 | 37 | 32 |
| 45 μm in diameter (per 50 g) | | | | | | | |
| Total number of magnetic colored particles and magnetic non- | 33 | 41 | 45 | 54 | 39 | 38 | 32 |
| colored particles of no less than 45 μm in diameter (per 50 g) | | | | | | | |
| Proportion of number of magnetic colored particles of no less | 0 | 0 | 2 | 4 | 3 | 3 | 0 |
| than 45 μm in diameter (%) | | | | | | | |
| Proportion of number of particles oxidized down to central | 80 | 80 | 60 | 50 | 70 | 70 | 70 |
| portion (%) | | | | | | | |
| Average particle diameter of spherical silica powder and | 27 | 31 | 8 | 6 | 45 | 51 | 27 |
| spherical alumina powder (μm) | | | | | | | |
| Average sphericity of spherical silica powder and spherical | 0.92 | 0.91 | 0.96 | 0.95 | 0.92 | 0.90 | 0.95 |
| alumina powder (-) | | | | | | | |
| Number of short circuit failures in semiconductor (per 30 | 0/30 | 0/30 | 0/30 | 0/30 | 0/30 | 0/30 | 0/30 |
| semiconductor) | | | | | | | |
| Average of maximum wire deformation volume (μm) | 15 | 17 | 26 | 24 | 21 | 25 | 17 |

TABLE 3

| | | Examples | | | | | | |
|---|---|---|---|---|---|---|---|---|
| | | 1 | 2 | 3 | 4 | 5 | 6 | 7 |
| Type of raw material powder | | Crystalline | Alumina A1 | Crystalline | Alumina A2 | Crystalline | Alumina A3 | Crystalline |
| | | silica S1 | | silica S2 | | silica S3 | | silica S1 |
| Average particle diameter of raw material powder (μm) | | 26 | 31 | 5 | 3 | 45 | 51 | 26 |
| Amount of raw material powder injected to flame (kg/hr) | | 140 | 140 | 100 | 100 | 150 | 150 | 140 |
| Oxygen carrier gas flow rate (m³/hr) | | 12 | 12 | 12 | 12 | 12 | 12 | 12 |
| Flame forming gas | Propane gas | 24 | 24 | 24 | 24 | 24 | 24 | 24 |
| flow rate (m³/hr) | Oxygen gas | 135 | 135 | 135 | 135 | 135 | 135 | 135 |
| Conditions of gas | Type | Oxygen | Oxygen | Oxygen | Oxygen | Oxygen | Oxygen and | Water vapor |
| supplied | | | | | | | water vapor | |
| | Total flow rate of 4 sites (m³/hr) | 70 | 70 | 40 | 40 | 45 | 45 | 85 |
| | Ratio of raw material | 0.5 | 0.5 | 0.4 | 0.4 | 0.3 | 0.3 | 0.5 |
| | powder (m³/kg) | | | | | | | |
| | Ambient temperature | 1800 | 1800 | 1600 | 1600 | 1700 | 1700 | 1700 |
| | in furnace (° C.) | | | | | | | |
| | Supply angle (°) | 90 | 90 | 90 | 90 | 60 | 60 | 90 |

| | | | | | | | |
|---|---|---|---|---|---|---|---|
| Peripheral speed of rotary valve (m/s) | 3 | 3 | 3 | 3 | 3 | 3 | 3 |
| Number of magnetic colored particles of no less | 0 | 0 | 1 | 2 | 1 | 1 | 0 |
| than 45 μm in diameter (per 50 g) | | | | | | | |
| Number of magnetic non-colored particles of no less | 33 | 41 | 44 | 52 | 38 | 37 | 32 |
| than 45 μm in diameter (per 50 g) | | | | | | | |
| Total number of magnetic colored particles and magnetic | 33 | 41 | 45 | 54 | 39 | 38 | 32 |
| non-colored particles of no less than 45 μm in | | | | | | | |
| diameter (per 50 g) | | | | | | | |
| Proportion of number of magnetic colored particles | 0 | 0 | 2 | 4 | 3 | 3 | 0 |
| of no less than 45 μm in diameter (%) | | | | | | | |
| Proportion of number of particles oxidized down | 80 | 80 | 60 | 50 | 70 | 70 | 70 |
| to central portion (%) | | | | | | | |
| Average particle diameter of spherical silica powder | 27 | 31 | 8 | 6 | 45 | 51 | 27 |
| and spherical alumina powder (μm) | | | | | | | |
| Average sphericity of spherical silica powder and | 0.92 | 0.91 | 0.96 | 0.95 | 0.92 | 0.90 | 0.95 |
| spherical alumina powder (−) | | | | | | | |
| Number of short circuit failures in semiconductor | 0/30 | 0/30 | 0/30 | 0/30 | 0/30 | 0/30 | 0/30 |
| (per 30 semiconductor) | | | | | | | |
| Average of maximum wire deformation volume (μm) | 15 | 17 | 26 | 24 | 21 | 25 | 17 |
| [symbol] | | | | | | | |

[symbol]

indicates data missing or illegible when filed

As was apparent from a comparison between Examples and Comparative Examples, the semiconductor sealant containing at least one of the spherical silica powder and the spherical alumina powder of the present invention could substantially reduce the number of short circuit failure in a sealed semiconductor. With at least one of the spherical silica powder and the spherical alumina powder of the present invention, a semiconductor sealant that is preferably used in a semiconductor of a smaller size and higher density can be provided.

### INDUSTRIAL APPLICABILITY

The powder of the present invention composed of at least one of a spherical silica powder and a spherical alumina powder can be used as a semiconductor sealant used in an automobile, portable electronic device, personal computer, household appliance and the like, and as a filler for a laminated plate on which a semiconductor is mounted. The resin composition of the present invention can be used not only as a semiconductor sealant, but in manufacturing a prepreg for a printed substrate, various engineering plastics and the like, by impregnating a glass woven fabric, glass nonwoven fabric, and other organic base materials with the resin, and then curing the resin.

1. A powder comprising at least one of a spherical silica powder and a spherical alumina powder, wherein a proportion of a number of magnetic colored particles of no less than 45 μm in diameter is no greater than 20% with respect to a total number of the magnetic colored particles of no less than 45 μm in diameter and magnetic non-colored particles of no less than 45 μm in diameter, in a case where a color reaction test is conducted, the color reaction test including steps of:
(1) preparing a slurry, by way of precisely weighing 50 g of a powder sample and dispersing the powder sample in 800 g of ion-exchanged water;
(2) obtaining the total number of the magnetic colored particles of no less than 45 gm in diameter and magnetic non-colored particles of no less than 45 μm in diameter, by way of capturing magnetic particles by immersing a bar magnet of 10000 gauss covered by a rubber cover of 20 μgm thickness in the slurry, sifting the magnetic particles with a polyester filter of 45-μm mesh size, counting a number of the particles remaining on the filter; and
(3) wetting the particles by way of dripping 0.5 ml of a mixed solution comprising equal parts of 10% by mass hydrochloric acid water solution, 50% by mass propylene glycol water solution, and 0.5% by mass potassium ferricyanide water solution, on the particles on the filter at a room temperature of 20° C., then leaving to stand for 20 minutes, counting a number of particles thus colored as the magnetic colored particles of no less than 45 μm in diameter, and calculating the proportion of the number of magnetic colored particles of no less than 45 μm in diameter present among magnetic particles of no less than 45 μm in diameter by an equation (Number of magnetic colored particles of no less than 45 μm in diameter)×100/(Total number of magnetic colored particles of no less than 45 μm in diameter and magnetic non-colored particles of no less than 45 μm in diameter).

2. The powder according to claim 1, wherein the number of the magnetic colored particles of no less than 45 μm in diameter is no greater than 5 per 50 g.

3. The powder according to claim 1, wherein the total number of the magnetic colored particles of no less than 45 μm in diameter and magnetic non-colored particles of no less than 45 μm in diameter is no greater than 50 per 50 g.

4. The powder according to claim 1, wherein a proportion of a number of particles oxidized down to a central portion thereof is no less than 60%, the proportion being calculated after the color reaction test by performing a step of:
(4) selecting magnetic non-colored particles having a particle diameter after the color reaction test of no less than 45 μm, embedding with epoxy resin, curing, cutting and polishing to expose a cross-section of the particle, analyzing for the existence of oxygen in a center of the cross-section using energy-dispersive X-ray spectroscopy (EDS), counting a number of particles in which oxygen is detected in the center of the cross-section thereof as a number of particles oxidized down to a central portion thereof, and calculating the proportion of the number of particles oxidized down to the central portion thereof present among magnetic non-colored particles of no less than 45 μm in diameter by an equation (Number of particles oxidized down to a central portion thereof)×100/(Number of magnetic non-colored particles of no less than 45 μm in diameter),
wherein analysis conditions of the EDS are: accelerating voltage of 15 kV; illumination current of 10 nA, magnification of 2000 times, elapsed time for each pixel of 100 msec, pixel size of 0.2 μm square, and pixel count of 256×256 pixels.

5. The powder according to claim 4, wherein the proportion of the number of particles oxidized down to a central portion thereof that is calculated in step (4) is no less than 70%.

6. The powder according to claim 1, wherein the powder has an average sphericity of no less than 0.75 and an average particle diameter in a range of 3 to 50 μm.

7. A manufacturing method of a powder consisting of at least one of a spherical silica powder and a spherical alumina powder, comprising a process of fusing at least one of a silica raw material powder and an alumina raw material powder by a flame formed inside a furnace, sphering, transferring to outside of the furnace, and collecting a spherical powder,
wherein the process includes steps of: supplying 0.3 to 0.6 m³ of at least one of oxygen gas and water vapor per 1 kg of a raw material powder to at least one arbitrary site inside the furnace where an ambient temperature is in a range of 1600 to 1800° C., at an angle of 60° to 90° with respect to an injection direction of the raw material powder; and
between fusing and sphering of the raw material powder and collecting the spherical powder, in a portion where at least one of the raw material powder and the spherical powder contact at least one of stainless steel and iron, making a relative velocity therebetween no greater than 5 m/s.

8. The manufacturing method according to claim 7, wherein the powder consisting of at least one of a spherical silica powder and a spherical alumina powder is the powder according to any one of claims 1 to 6.

9. A resin composition comprising the powder according to claim 1.
